(19) United States
(12) Patent Application Publication
(10) Pub. No.: US 2021/0174625 A1
(43) Pub. Date: Jun. 10, 2021

(54) MULTI-LEVEL INTEGRATED UTILITY TO COLLECT AND PROVIDE INFORMATION AND EFFECTUATE POLITICAL ACTIONS

(71) Applicants: James P. Pinkerton, Rosslyn, VA (US); Gregory A. Piccionelli, Westlake Village, CA (US)

(72) Inventors: James P. Pinkerton, Rosslyn, VA (US); Gregory A. Piccionelli, Westlake Village, CA (US)

(21) Appl. No.: 16/779,332

(22) Filed: Jan. 31, 2020

Related U.S. Application Data
(60) Provisional application No. 62/799,841, filed on Feb. 1, 2019.

(51) Int. Cl. G07C 13/00; G06F 16/27

(52) U.S. Cl. CPC G07C 13/00; G06F 16/27

(57) ABSTRACT

A media campaign management approach that enables two-screen communication between stars and an audience.

### RELATED APPLICATIONS

This application claims priority to U.S. Provisional Application No. 62/799,841, which was filed on Feb. 1, 2019, titled “MULTI-LEVEL INTEGRATED UTILITY TO COLLECT AND PROVIDE INFORMATION AND EFFECTUATE POLITICAL ACTIONS” that is also incorporated herein in its entirety.

### TECHNICAL FIELD

The present invention relates generally to systems, methods, and devices that enable users to effectively participate in media campaigns including political campaigns that effectuate actions and otherwise derive political, economic and social benefits through integration of information dissemination, data collection and the effectuation of one or more political actions.

### BACKGROUND

Media campaigns for political and marketing purposes have become more and more important. But the combination of electronic or internet advertising, social media, and marketing messages has numbed the public to such messages. More and more “fake” messages have also been disseminated and caused confusion in the political processor, consumer market place, and social institutions, further numbing the public to such media campaigns.

Additionally, a problem with media campaigns (political and/or marketing) is the ability to predict their success during the campaign and just not upon completion. Waiting for an election to be completed to determine the success of the political message presented by the candidate leaves no time for taking any corrective actions.

One of the essential problems with media campaigns arises from what is termed “The Two-Screen Status Quo—Passive News and Active Empowerment.” If we think about the way people interact with politics (political/media campaigns) in their daily lives, a “the two-screen dilemma” problem becomes apparent. Essentially, in political media campaigns today, most Americans need to use two vastly different modes of communication and interaction, which can be characterized literally as well as metaphorically as “screens.” These screens, respectively associated with passive news, education and marketing consumption and active political, social, or commercial empowerment, are not currently interchangeable or fully integrated. If the two screens and the modes of activity characterized by each, were to become interchangeable, however, and, as a result, people needed only one screen, i.e., one efficient means, to obtain political, social, or commercial information and effectuate action through that empowerment, qualitatively better levels of media campaign success may be achieved with greater efficiency and likelihood of desired political, social, or commercial outcomes. Such an improvement in the linkage between citizen “input” and political “output” is a social good, as well as an economic good. That is, if political accountability can be improved, then the linkage between voters and their government is strengthened.

The problem that the “two-screen status quo,” imposes is: The “first screen” is the one that is watched to learn about politics, social, or commercial issues: If it is a television screen, it is almost always one-way. That is, one watches it. And the same one-way-ness holds true for most online news-media outlets (what are still quaintly known as “newspapers,” “magazines,” “radio,” or “TV”); usually, the most one can do is post a comment, or perhaps click on a banner ad. Thus, the material on this first screen as passive news.

The second screen is the one on which one takes action in the media campaign: This would be a computer (or handheld) screen, in which a user can more easily sound off in a directed or concerted way. That is, directed to a given recipient, or concerted toward a cause, as part of a petition-group or coalition. In some cases, on this “second screen,” a person might even apply for an absentee ballot. We can dub the material on this screen, and what it enables persons to do, as active empowerment.

A dilemma exists, as in, having two horns. After passively observing the media campaign on the first screen, persons must shift to the second screen to actively do anything in response to the first screen. Thus we can see: the first screen is passive, the second screen is active, and the twain doesn't easily meet. One view is that knowledge is power and that that's good enough. And yet it's activism or action that is the desired outcome of a media and/or political campaign. That is, in the end, the goal of a campaign is tangible action—electoral victory.

Therefore, what is needed in the art is an approach to conduct a media complain that promotes action or decision that provides feedback and ascertainable while eliminating the dilemmas created by the “two-screen” approach.

SUMMARY

An approach for the generation of an integrated system that enables users to obtain information, more specifically, marketing and/or politically relevant information, and to provide valuable or otherwise politically, socially or commercially relevant actions, such as voting, providing a campaign contribution, providing volunteer services, and the like. Such approaches have been generally referred to as “media campaigns.” Such a media campaign enables a marketing or political message to be presented to users through different media channels while getting feedback and in some cases receiving a commitment for an action, such as who a user will vote for, issue support for, or make a purchase in response to the media campaign.

Other devices, apparatus, systems, methods, features, and advantages of the invention will be or will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 depicts an illustration of an APS approach with processor-controlled server 102 that executes instructions that result in an example implementation of the invention.

FIG. 2 depicts an illustration of a processor-controlled client device 102 that executes instructions that result in an example implementation of the invention.

FIG. 3 depicts a block diagram of a high-level conceptual view of a “single-screen” APS approach in accordance with an example implementation of the invention.

FIG. 4 depicts a diagram of the APS media campaign fundamental units of the APS of FIG. 1 in accordance with an example implementation.

FIG. 5 depicts an application block diagram of the modules or software blocks that enable the APS server of FIG. 1 to function with the server hardware and is depicted in accordance with the example implementation.

FIG. 6 depicts a block diagram of a hierarchy of APS systems in accordance with an example implementation.

FIG. 7 depicts a block diagram of a blockchain data structure in accordance with an example implementation.

FIG. 8 depicts a diagram of the APS client displayed on the display of the processor-controlled client device of FIG. 2 in accordance with an example implementation.

### DETAILED DESCRIPTION

### Definitions

The terms below, and terms incorporated from the aforementioned listed patents and patent applications, and grammatical variations thereof, shall have the meanings provided. Notwithstanding and not limiting the foregoing, the following definitions as used in this disclosure are intended to be construed broadly so that the meanings will reasonably effectuate the broadest interpretation of all of the parts of this disclosure in which they are used. If a term is not defined, then its ordinary dictionary meaning is applied.

“APPlied” Politics and Applied Politics System (“APS”). An approach comprising an online platform or, in some embodiments of the invention, an interconnected network of platforms, accessible by a plurality of users via a plurality of smartphones, computers, virtual reality devices, and other digital devices enabling users to engage in both passive consumption of news and other information and active political participation through an integrated system that provides the system operator(s) with means to acquire and utilize a wide range of information about APS users obtained via APS Profiles, the IVE, and by other means, such as from Public Computers and databases associated therewith. Without limiting the foregoing “APS” shall also mean and include a system comprising the other embodiments of the invention described herein.

APS Profile. A composite identification of a person or organization using information about the person or organization from one or more data sources, such as social networks, personal activity data, interpersonal relationship data, location data regarding where the person or members of an organization are/or have been, voting history data, survey response data history, purchases history data, online search history data, Internet use data, data from one or more smart devices, automobiles and other devices used by the person, and other data comprising the person's life experience. In some embodiments of the invention, APS Profiles are created and generated based at least in part on one or more algorithms that have a threshold related to their political, social, public, personal activity. In some embodiments, one or more computers and/or applications using the APS are configured to monitor social media and/or other data sources to compile a composite profile of a person. In some embodiments, the aforementioned composite is assembled from and/or by the means set forth in U.S. patent application Ser. No. 13/668,304 the entire text of which is hereby incorporated by reference and included as though set forth in full. In some embodiments of the invention, the composite assembly of data in one or APS Profiles can be used to assemble a personal history or digital diary, including without limitation, a digital diary of the types disclosed in U.S. patent application Ser. No. 13/668,304. In some embodiments, new or related APS Profiles can be created regarding any form of life history data that is publicly available, including without limitation, marriage data, arrest data, court record data, property records data and other city or county records data, etc. The aforementioned aspects of preferred embodiments of the invention exploit the notion that a person is a composite of their actions, activities, interpersonal relationships, locations, and unique life experiences. Thus, APS Profiles in some such preferred embodiments are created and generated based on one or more algorithms related to the gathering of a person's social, public, and personal activity. In some embodiments of the invention, an APS Profile functions to provide a digital composite of a person from specific or aggregated online identity characteristics. Also, a composite of the person, such as an identity composite need not be limited to scraping data from public databases. It could also utilize private databases, including, for example, purchase data or even private data from an APS.

Blockchain. A “blockchain” is a digitized, centralized, decentralized, or both centralized and decentralized, public ledger of transactions. This may include but is not limited to crypto-currency, agreements, inventories, etc. This can include programmable Blockchains such as ETHEREUM's Blockchains. It is to be expressly understood that the definition of the term “Blockchain” shall not exclude, but shall also include, all commonly understood definitions of the term “blockchain” or “block-chain” in use or otherwise available to a person of relevant ordinary skill.

Brain Mapping. Brain Mapping means, in summary, the study of the anatomy and function of the brain and spinal cord through the use of imaging, immunohistochemistry, molecular & optogenetics, stem cell and cellular biology, engineering, neurophysiology, and nanotechnology. Without limiting the foregoing, “Brain Mapping” also means a set of neuroscience techniques predicated on the mapping of (biological) quantities or properties onto spatial representations of the (human or non-human) brain resulting in maps.

Compare, Comparison, and Comparing (and derivatives thereof). The terms “Compare,” “Comparison,” and “Comparing” (and derivatives thereof) mean the process of determining, measuring, noting, valuing, and/or estimating or otherwise comparing the similarity of data and/or other determinable information or other matter to other data, information and/or determinable matter, where such data, information or other determinable matter shall be construed broadly to mean anything that is comparable digitally or by any other means of comparison, including without limitation by means of computer-assisted comparison, operation of one or more autonomous computing devices to perform such comparison(s), use of one or more artificial intelligence devices to perform such comparison(s). Without limiting the foregoing, the terms “Compare,” “Comparison,” “Comparing” (and derivatives thereof) shall also include any means of effectuating a comparison of any quantifiable item or other matter to one or more other quantifiable items or other matters.

Communicate and communicate (and derivatives thereof). “Communicate” and “Communication” means data transmission and/or reception by and/or between devices, such as by and between computers, autonomous computer devices, artificial intelligence devices, robots and/or other digital devices or digitally enabled devices effectuated by, through or in association with any known means of data or other information communication by and/or between such devices, including without limitation, by transmission between digital device components, transmission over, through or in association with, one or more networks, by wired or wireless means, including without limitation by signal transmission.

Identity Verification Engine (“IVE”). The Identity Verification Engine (“IVE”) is a system providing functionality whereby an individual, person, group, persons, legal entity, non-human entity, including without limitation, an animal, an artificial intelligence (“AI”) entity, a non-human legal entity, and/or an item or group of items can have their identity verified by through the use of one or more Blockchains to store data comprising identification data and/or identification data verification data. In some embodiments of the invention, this data could comprise, but is not limited to, birth certificate copies, birth data, passport copies, passport data, fingerprint data, educational data (degrees, classes completed, grades, etc.), and/or other biographical information, such as physical characteristic data, job history, etc. In some such embodiments, once identity is verified (via one or more processes that provide data indicating that identification data has met a predetermined criterion or set of criteria) the IVE will securely store the verification data and all source records associated with the determination of identity verification in one or more Blockchains. In some embodiments, this information can be retrieved by authorized third parties, including without limitation, in some embodiments, an autonomous computing device, an AI device or a robot. In some embodiments of the invention, the IVE provides the means to enable a person, group, persons, legal entity, non-human entity, including without limitation, an autonomous computing device, an AI entity, and/or an item or group of items functionally capable of communication with IVE to verify and/or validate its/their identity, including through or by providing to the IVE identification verification data, identification source records, identification or other indicia of through but not limited to source records, such as data accessible in an independent database, such as a government records database. In some embodiments, the IVE is used by 3rd parties. In still other embodiments, the IVE can function as a plugin, such as, for example, a plugin feature of an APS.

Public Computer. A Public Computer can be but is not limited to any processor, database or application with open, or substantially open, access to the general public. This can include computing devices such as, for example, the computer hosting the Library of Congress website. Without limiting the foregoing, the term “Public Computer” shall also mean a limited access computer, program or application that has been configured to provide certain information/access to the public by one or more security means, including without limitation, for example, through the use of Blockchains and/or via one or more other digital devices on one or more non-private networks generally open to the public or use, including without limitation, information collected from, by, through, in association with one or more publicly accessible databases, such as social network databases, government databases, geo-tracking databases, online photo databases, property ownership databases, academic databases, purchase records, political donation databases, and charitable donation databases. In some embodiments of the invention, a “Public Computer” contains and uses information collected from one or more publicly accessible databases or other collections of digital data, including without limitation, data across social networks, data from geo-tracking database, photographic information, and records of activities, such as purchases, charitable donations, etc.

Secure Storage. Secure Storage means a secure storage device including but not limited to a secure, computer, Blockchain, hardware device (such as a cell phone, thumb drive, hard drive), genetic file, AI, physical location (safe).

Secure Verification Identifier. A Secure Verification Identifier is a type of unique identifier associated with an indicium of the identifier, such as a token, etc. Such indicia can be represented in some embodiments of the invention as a secure Blockchain token/badge/avatar, etc. In such embodiments, these tokens can have multiple levels of security/reliability, for example, silver, gold, platinum. In such cases, different levels of tokens may be configured to represent levels of reliability and integrity. These levels may be achieved by synchronized data and numbers of successful transactions. In some embodiments of the invention, publicly Compared data may be, how many times a party has been checked onto an airplane, when the person undertook their last driver's license renewal, etc. A Secure Verification Identifier can also be something imprinted on a tangible item, such as a credit card or chip. In some embodiments of the invention, a token can be configured to function as a Secure Verification Identifier. In some embodiments of the invention, the Secure Verification Identifier comprises an organic indicia of identification, such as a retina tattoo. In some preferred embodiments, the Secure Verification Identifier can be modified in a way that it can be but is not limited to being constructed in a way that is in compliance with government requirements, financial institutional requirements, educational institutional requirements, corporate institutional requirements, and personal requirements.

Semi-Private. “Semi-Private” means in association with the APS and or one or more APS Profiles and/or other data stored in the APS and/or one or more associated devices (such as servers) by a select plurality of entities, including without limitation non-human device entities, such as robots or artificial intelligence entities, or groups thereof, across multiple computers, servers or similar devices, whereby access to the ledger(s) is limited to persons or entities, including without limitation non-human device entities, such as robots or artificial intelligence entities, with predefined or otherwise appropriate credentials.

Source Records. Source Records means any type of documentation about a person/entity confirming, recognizing or verifying the experience, completion or interaction of the Source Record holder. This could be but is not limited to a birth certificate, education degrees, school records, work history, social security number, etc. In some preferred embodiments, Source Records used in association with an IVE will be confirmed by a person, computer, AI, Group, Corporation, Entity, Government for the IVE through but not limited to visual inspection, physical inspection, holographic inspection, comparison with a third-party database inspection, AI inspection, remote device inspection (e.g., through a camera, cell phone or other type of device), use of one or more previous or pre-existing IVE confirmations or Secure Verification Identifiers, etc. In some embodiments, Source Records are compared with existing public records, private records, financial records, medical records, government records, criminal records, personal records

### The APPlied Politics System (“APS”): A Media Campaign Platform for Political, Social, and Commercial Empowerment

The “APS” is an approach for media promotion, in the preferred implementation a political campaign will be employed. The approach is implemented with servers located in a network or cloud communicating with one or more clients. In some implementations, multiple servers may communicate with each other and multiple clients in a distributed networking approach. Data associated with the media campaigns may be stored on a server running the APS application or in distributed databases or a combination of local and distributed databases.

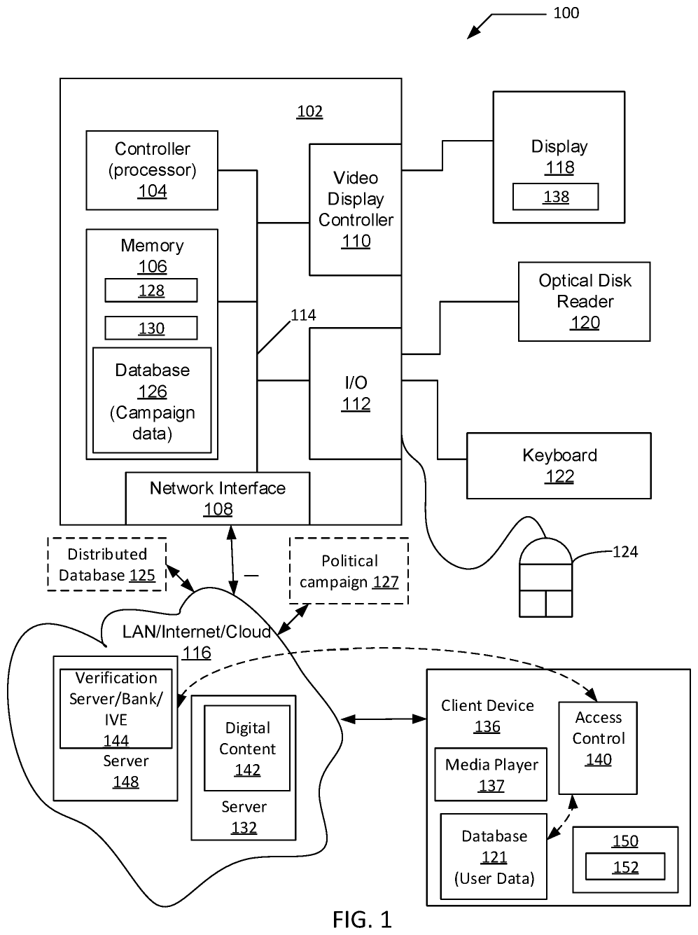

Turning to FIG. 1, an illustration 100 of a processor-controlled device 102 that is able to access a database 126 associated with the storage and delivery of content with associated media campaign or political campaign management in accordance with an example implementation of the invention. The processor-controlled device 102 (APS server) may be a server implementing or hosting the “APS” system and have the control, system, and security portions of control for the depicted example implementation. In other implementations, the processor control device may be combined with other portions of the system or distributed among other devices and/or servers.

The processor control device may have at least one controller 104 (processor) coupled to a memory 106, network interface 108, video controller 110, and input/output (I/O) interface 112 by address/data bus 114. The network interface 108 may couple the processor-controlled device 102 to a network, such as one or more local area networks (LANs)/internet/cloud 116 and servers, such as server 132 located in the cloud 116. The connection to the LANs/internet/cloud 116 may be wired or wireless (such as IEEE 802.11g or 802.11n standards). The video controller 110 may be coupled to one or more displays, such as display 118. The display is typically a digital video display, such as HD television, VGA computer display, OLED display, and/or LED display. The I/O interface 112 may be coupled to a keyboard 122, optical disk reader 120, and mouse 124.

The controller 104 executes instructions that may be stored in memory 106 that facilitate the operation of the processor-controlled device 102. The memory 106 may be logically or physically split into an operational memory 128 that provides operational instructions for the processor-controlled device 102 and an application memory 130. The memory 106 may have one or more databases, such as database 126 stored therein for access by the application when executed by the controller 104 stored in application memory 130. The database may be a SQL or other relational database. In yet other implementations, data structures may be encoded to act as a database. In other implementations, the application memory 130 may be dedicated to one application. An initial naming convention may initially be loaded into application memory 130, where the initial naming definition file is a typical approach to naming different elements in the database 126 and contains partial names, such as suffixes and/or strings of text.

The database 126 may be a portion of a larger database, distributed database 125, or simply data written or read from the distributed database 125 and otherwise copied into memory 106 by the controller 104. In other implementations, the database 125 may be read in real-time or be located in the cloud or an external network. In yet other implementations, the database may have been previously stored in the memory or disk storage of server 132. The database 125 contains data elements, user data, digital content location data, and consumer product information, including reward amounts, associated test information, loyalty program information, in addition to data required to support the approach of the example implementation.

The client device 136, such as a computer, tablet, smartphone, or smart device has an APS access control or client 140 that enables secure access to server 102. The client device 136 may have a media player 137 or other applications that are able to read/play/display data from the APS system. The media player 137 that interacts with the access control 140 and is able to at least play digital content 142 stored on server 142 and or otherwise referenced by the APS server 102. In other implementations, the media player 137 may be a web browser plugin. In other implementations, the media player 137 may be a dedicated application for playing media, displaying media (text reader), browser, or other application. A display 150 enables the accessed media from the media player 137 or other applications to be displayed. Similarly, the display 150 may display a graphical user interface 152 that enables data to be entered into the client device via a touchscreen. In other implementations, an additional interface may enable keyboards, mice, trackballs to interface with the graphical user interface 152. User data may be stored in database 121 that contains user data required to access the APS server 102 and the digital content 142 contained in the digital content server 132. The digital content server 132 with digital content 142 in other implementations may be internal to the APS server 102. In yet other implementations, the digital content 142 may be implemented with other remote devices.

The application in the application memory 130 is executed by the controller 104 and results in a graphical user interface 138 appearing on display 118 for management and configuration of the APS server 102. The management and configuration of the APS server 102 enable association of the digital content 142 that may be associated with message placement from an external political campaign 127 or advertisement produced by the external campaign 127.

Upon logging into and verification of the user of the APS server 102 via the access control 140 of the client device 126 and the verification server/bank/IVE server 144 that may reside on server 148. The user may access and view digital content 142 (that resides on one or more digital content servers, such as digital content server 132), view and/or manage their earned credits that may be recorded in the verification server/bank/IVE 144 on server 148. In other implementations, the verification server/bank 144 may be collocated with other servers such as digital content server 132 and APS server 102.

Credits may be earned by the user of the client device 136 by viewing digital content 142, participating in campaign activities, and social media. The digital content may be video, audio, video games, computer programs, pictures, eBooks, news articles, or a combination of the video, audio, video games, computer programs, news articles, and pictures. In yet other implementations, the digital content may be distributed among multiple APS servers where each server (or a plurality of servers) support a different language of digital content. In other implementations, the APS servers may manage multiple versions of digital content where the content is in different languages. credits may be provided for actions, such as viewing the digital media, taking the test, surveys, making posts.

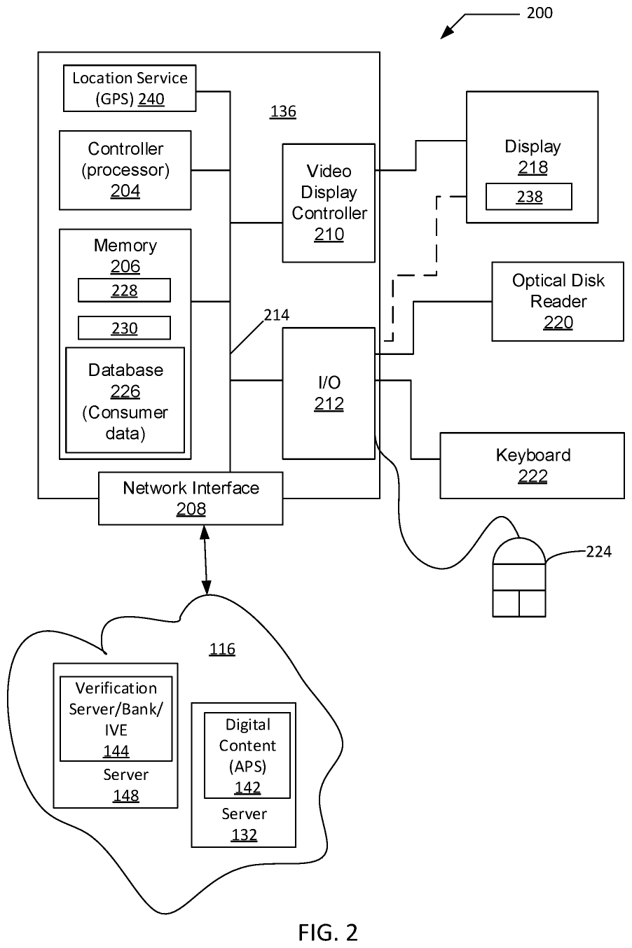

In FIG. 2, an illustration 200 of a processor-controlled client device 136 that is able to access a database 226 associated with the storage of content on the client in accordance with an example implementation. The processor control client device 136 may have at least one controller 204 (processor) coupled to a memory 206, network interface 208, video controller 210, location service (GPS) 240 and input/output (I/O) interface 212 by address/data bus 214. The network interface 208 may couple the processor-controlled device 202 to a network, such as one or more local area networks (LANs)/internet/cloud 116 and servers, such as server 132 with an APS and/or digital content 142 located in the cloud 116. A server 148 with one or more of verification/IVE/bank server applications 144 may be present in the cloud/network 116 and able to communicate with the processor-controlled client device 136. The connection to the LANs/internet/cloud 116 may be wired or wireless (such as IEEE 802.11g or 802.11n standards). The video controller 210 may be coupled to one or more displays, such as display 218. The display is typically a digital video display, such as HD television, VGA computer display, OLED display, and/or LED display. The I/O interface 212 may be coupled to a keyboard 222, optical disk reader 220, and mouse 124 (or pen not shown). Location Service 240 is coupled to bus 214 and provides the location of the client device 136 to the controller 204. Typically the Location Service 240 is implemented as a Global Positioning System (GPS) receiver.

The controller 204 executes instructions that may be stored in memory 206 that facilitate the operation of the processor-controlled client device 136. The memory 206 may be logically or physically split into an operational memory 228 that provides operational instructions for the processor-controlled client device 136 and an application memory 230 with the APS client application. The memory 206 may have one or more databases, such as database 226 stored therein for access by the application when executed by the controller 204 stored in application memory 230. The database may be a SQL or other relational database. In yet other implementations, data structures may be encoded to act as a database. In other implementations, the application memory 230 may be dedicated to one application. An initial naming convention may initially be loaded into application memory 230, where the initial naming definition file is a typical approach to naming different elements in the database 226 and contains partial names, such as suffixes and/or strings of text.

A concept underlying the example implementation is the notion that a single application, essentially “one screen” solution, lets the viewer/citizen do just about everything in a media campaign, such as a political campaign, both as a passive news consumer and as an active political participant using the APS processor-controlled client 136 interacting with an APS server 102. At the same time, the core integrated “one screen” political campaign enables professional politicians, and political activists, to have much greater visibility into the citizenry, better enabling them to seek out potential supporters, including, most importantly, voters. Thus, one of the underlying concepts of the instant invention is the recognition that ideas of political “consumer” and political “producer,” traditionally seen as separate and distinct, may be blended together, into one seamless, and holistic, connectivity through the APS.

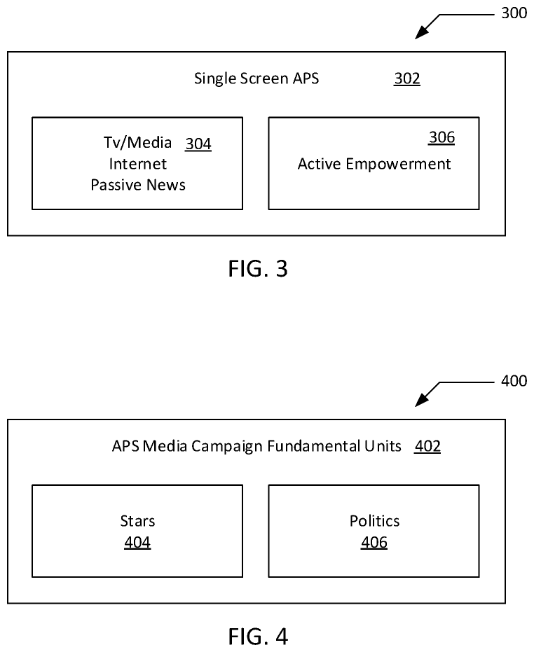

In FIG. 3, a block diagram 300 of a high-level conceptual view of a “single-screen” APS approach 302 is depicted in accordance with an example implementation of the invention. A user is both a media consumer 304 and have active empowerment 306 to take action and receive rewards.

Turning to FIG. 4, a diagram 400 of the APS media campaign fundamental units 402 of the APS of FIG. 1 is depicted in accordance with an example implementation. The two fundamental units in an APS media campaign are: First, the media communicator traditionally called talent but because we will be including politicians, not typically seen as talent, in this definition of an APS fundamental unit, we assign the name to this collective unitary category: Stars 404. Second, the mass of the people or users, who function in two modes: as viewers, and also, as actors (i.e. voters in a political media campaign) are grouped or classed under a single category, or unit, which we call “Audience/Voters” 406.

For most people, the two-screen duality is merely inconvenient and inefficient; that is, they learn on one screen, and then they do on the other. That is, the individual must shift from the first screen to the second, as needed. There is also another problem with the two-screen status quo: candidates and politicians (stars 404) typically don't efficiently, or sometimes even eventually, find their rightful or most compatible audience and users of the APS. The decline of the “old” news media has meant a decline of coverage for most politicians, especially those involved in state and local politics. To be sure, there's plenty of coverage of national political news, at least the part of it revolving around political figures judged to be most compelling and urgent. However, most other politicians, and their ideas, are necessarily scanted.

But while traditional media entities know how to build an audience, at the same time, since traditional media lacks interactivity, it isn't as valuable as it could be. Moreover, upon reflection, it shouldn't be much of a surprise that traditional media isn't good at fully utilizing new technology to reap all the potential benefits of such audience-building. Traditional media is, after all, old technology. On the other hand, active empowerment, too, has a key weakness. It typically lacks the benefits of audience-building skills—the “human touch.”. That is if interactive media is only a transactional platform—that is, not news, especially entertaining or engaging news—then it's not likely to have a big audience, and certainly not a “sticky” audience.

Simply stated, the fundamental aim of APPlied Politics (APS), is to develop a two-way street, as it were, between Stars' 404 Politics 406 and the audience. In the same way that looking into the night sky in search of a particular star is challenging for most people—because all but experts have a hard time knowing what they're looking for—so it is with media campaigns and politics with political campaigns. Thus it's hard for citizens and politicians to connect, let alone for them to see the political equivalent of constellations. Essentially, the APS fills the need to find a way to help people see, and identify, the political Stars that they are looking for in the current political campaign example. Just as stellar navigation is easier when stars are visible, because of the light they provide to the navigator, so it would also be easier for people to identify their political Stars if they were empowered with an effective means of communicate to those in search of them. The APS comprises a new and useful tool that enables voters, activists, and politicians to find and interact with each other.

Specifically, it's easy to see that the new media model employed by the APS approach in the current example would be a format in which the main Stars are the political Stars. That is, each political Star, boasting his or her own micro-channel, would be largely responsible for pulling in an audience. The audience might be smaller than a traditional media audience, but at the same time, a microchannel audience, because of its specificity and focus, would be more likely to attract a high-quality audience from a political perspective, i.e., one that could potentially contain a greater proportion of likely and certain voters. This approach used in the APS also enables like-minded people to virtually congregate together. Once the APPlied Politics model (APS) described herein is put in place, familiar media strategies could also be put in place in association therewith.

Presently, the specter of cable TV “cord-cutting” gives added urgency to the search for new media campaign approaches—including political campaigns. That is, if the status quo is deteriorating, then the urgency of finding a new equilibrium is underscored. It hardly serves the interests of Stars if they can no longer find their audience—and if their Audience/Voters 406 can no longer find them. We might further add that rising concerns over censorship of legitimate political speech also make the case for the further evolution of communications systems that enables direct communication of Stars 404 and to their Audience/Voters 406.

So as a matter of good public policy, many political experts advise that we should strive for frictionless ways for people to exercise their constitutional rights to both be informed and to participate in public life. And that striving for such frictionlessness should also apply to candidates, politicians, and activists (i.e. stars 404) so that more voices can be heard and more endeavors undertaken. And it should also apply to the process of voting.

Also, as a matter of good public policy, it is self-evident that we should also always be striving to make politics as secure and tamper-proof as possible. And so we should be seeking to harness the best available technologies to the task. The most advanced identity technologies—including geolocation, as well as biometrics such as fingerprint and facial recognition—are typically found in the private sector, where they have been mostly focused on securing financial transactions. The security of digital data is maintained in the current example with the use of blockchains for user data. In some implementations, the security of digital content can be assured via the use of blockchain.

It would, of course, be beneficial for American democracy if these best practices could be transferred as rapidly as possible to the public sector. Especially, of course, they should be applied to the goal of making sure that actual voting is secure and sacrosanct. Yet relatively few of the rigorous identity technologies used in the private sector are applied to voting and other political processes. Consequently, there is a long-felt need to incorporate advanced identity technologies into voting and other political activities. In preferred embodiments of the invention, the APS, utilizing the Identity Verification Engine (“IVE”) and one or more Secure Verification Identifiers addresses that need and does so while simultaneously addressing the two-screen problems discussed above.

We can pause to note that peer-to-peer (P2P) technologies, such as blockchain technologies, are offering new vistas of efficient secure relationship-building across the economy, and yet so far at least, politics has lagged. For instance, blockchain, and AI, allow for a much smarter and deeper form of interaction. For instance, the viewer could type in, or say, “I want to learn more about what Host X or Politician Y has to say about taxes or education, and I want the information not only from him or her, but also, I want it in the form that I wish, and I also want other contextual information.” With good tools, including voice recognition, it would be easy enough to find this information and serve it up to the viewer—who is, after all, also a voter. Similar relationship-building is possible among viewer-activists themselves, as they seek to make deeper connections with each other, out in the grassroots. Such efforts are often inherently reasonable, especially if the news consumer is known to be a solid activist because a known activist or voter is worth a lot more to a campaign than just a citizen of unknown inclinations. And so politicians, and political organizations, and others, are likely to provide the requested information, in as much quantity as the viewer might seek. Indeed, they might well be bidding, with real money, to APPlied App for the right to provide this information.

The APS comprises an online platform or, in some embodiments, an interconnected network of platforms (server 102), accessible by a plurality of users via a plurality of smartphones, computers, virtual reality devices, and other digital devices (processor-controlled client device 136) enabling users to engage in both passive consumption of news and other information and active political participation through an integrated system that provides the system operator(s) with means to acquire and utilize a wide range of information about APS users obtained via APS Profiles, the IE, and by other means, such as from Public Computers and databases associated therewith. In some preferred embodiments, such other means also include and one or more sensor devices and associated databases, such as devices capable of determining and recording user location in association with a smartphone, computer-configured automobile or other computer devices, via geolocational means.

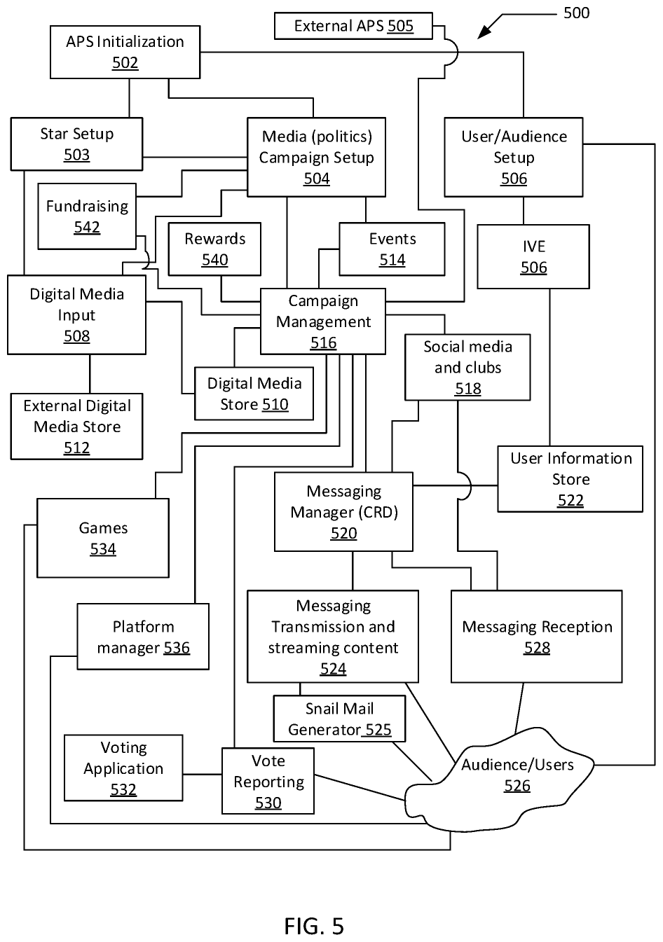

Turning to FIG. 5, an application block diagram of the modules or software blocks 500 that enable the APS server 102 of FIG. 1 to function with the server hardware is depicted in accordance with the example implementation is depicted. The APS' software blocks that make the APS server application is coded with one or more high-level programming languages, such as C, C++, Java, Python, SQL language, HTML, and Ada to give but a few examples by an operating system executed by the processor 104 such as windows server, or Linux to give but a few examples. The APS server application is initialized 502 or run on the server and starts a number of processes that support its operation. Part of initialization includes allowing one or more administrators to configure/setup the operation of the APS server, which includes defining databases, data structures, and/or Blockchains which in are encompassed by the broad term “data store” or “database,” such as database 125 or 126 of FIG. 1. The APS initialization communicates with the Star Setup Module 503, Media Campaign setup 504, External APS systems 505, and user/audience setup module 506. The inter-module communication may be facilitated by the operating system, using memory, or facilitated by the programing language.

One or more “Stars” may be configured using the Star Setup module 503. The Star Setup Module 503 communicates with the Media Campaign Setup Module 504 and the Digital Media Input 508. The star configuration data is then stored in a Star data database or part of a larger database that has structures defined for the Star data. The Star Setup Module 503 enables a “Star” to be associated with one or more identifies, such as name, political party, political post running for, age, or other identifying characteristics pertinent for a media or political campaign. The permissions for modifying data in the APS system are also set or configured using the Star Setup Module 504. Such permissions include setting up a media campaign, changing their “Star” parameters, sending messages, receiving messages, adding digital media. Furthermore, at “Star” may also configure “planet users” who they can share their roles with by assign permissions for those roles that managing parts of the media campaign. Examples of a “planet user” is a social media manager, email manager, digital media manager, event manager, reward manager, games manager, to name but a few. The planet users and their permissions are similarly stored in a “database”, such as database 125, 126 of FIG. 1.

Similarly, a media campaign (political campaign) is defined with the Media Campaign Setup Module 504. The Media Campaign Setup Module 504 communicates with the APS initialization Module 502, Star Setup Module 503, Fundraising 542, Digital Media Input Module 508, Campaign Management Module 516, Events Module 514. The definition of the media campaign contains information specific to the campaign such as persons or products being promoted. Required legal or regulatory information. For example, a political campaign may have petitions and election documents, office, election date, party affiliation, the duration for the campaign for an election. For a media campaign, for example, the product, product information (i.e. drug information, side effects, etc . . . ), duration, manufacture. The Media campaign setup module also defines what other modules will be accessible or used with the campaign, such as social medial and clubs module 518, games module 534, messaging manager module 520, platform manager 536, vote reporting module 530. Thus, the APS approach can be marketed with different capabilities costing different amounts.

The Campaign Management Module (CMM) 516 manages the media campaign and interactions between the stars and the audience/users. The Campaign Management Module 516 communicates with the Media Campaign Setup Module 504, Rewards Module 540, Events Module 514, Social Media and Clubs Modules 518, Messaging Manager Module 520, Voter Reporting 530, Platform Manager 536, Games Module 534 Digital Media Store 510 and the Fundraising Module 542. The Campaign Management Module 516 coordinates the activities and communication of the media and/or political campaign. Other modules are accessed by the CMM 516 to facility fundraising, sending digital media, social media messages, notices about events, messages to clubs, games, and give rewards. Unlike traditional two-screen approach, users, audiences, clubs, social media users respond to the activities initiated by the CMM activities 516.

An example of the CMM 516 in operations, is a Star sending an event notice for an event that is defined in the Events Module 514 to the Audience via the Messaging Manager 520 and Messaging Transmission and Streaming Content Module 524 to the Audience/Users 526. When the event occurs, the client application sends back a message using GPS or other location identification services, or the Audience/Users 526 are prompted to notify the CMM 116 via a message received by the messaging reception 528 that they are at the event. The CMM 516 via the Messaging Manager Module 520 then issues a reward to the Audience/Users 526 who attended the event via the Rewards Module 540.

The CMM 516 also is able to send and receive communication from Social Media and sub-groups (i.e. clubs) of the Audience/Users 526 using the Social Media and Clubs Module 518. Examples of Social Media include TWITTER, FACEBOOK, and INSTAGRAM, to name but a few. The interface to send and receive messages between the CMM 516 and social media is the Social Media and Clubs Module 518. Once again, this is another example of the APS approach promoting/providing a two-screen approach for the media campaign defined in the Media Campaign Setup Module 504. In other implementations, clubs may be virtual clubs or meet-ups as described in U.S. Pat. No. 9,652,114, titled “SYSTEM FOR FACILITATING IN-PERSON INTERACTION BETWEEN MULTI-USER VIRTUAL ENVIRONMENT USERS WHOSE AVATARS HAVE INTERACTED VIRTUALLY,” issued on May 16, 2017, and incorporated by reference in its entirety herein.

[symbol]

In an attempt to prevent “fake news” or digital content from being distributed, a digital Media Input module 508 enables digital content to be loaded into the APS system and securely stored in the Digital Media Store 510. Such secure storage may be with encryption or blockchain. Thus, any modified digital content that is found can quickly be compared to the original and identified. Also, the digital media may be watermarked by the Digital Media Input Module 508 prior to entry or storage in the Digital Media Store 510. When messages are sent to the Audience/Users 526 they can include digital media stored in the Digital Media Store and provide links to digital content in the Digital Media Store 510 that may be streamed by the Audience/Users. Part of the Messaging Manager Module 520 is the secure storage of outgoing media campaign messages. That storage may be in a database and/or blockchain and depending upon the implementations by be further encrypted. The storage of the messaging of the media campaign messaging may be used for compliance or security purposes and can be accessed via the CMM 516.

The Events Module 514 communicates with the Media Campaign Setup module 504 and the CMM 516. The Events Module 514 is initialized by the Media Campaign Setup Module 504 and enables campaign events to be planned, scheduled, reminders sent out to the Audience/Users 526 and track attendees. Using the CMM 516, an event is scheduled and planned. The planning of the event enables receipts, contracts, and other documents associated with the event to be organized and stored in the datastore that is part of the Events Module 514. In other implementations, the data store may be a common or combined APS data store. The storing of event data aids compliance verification and auditing of the media campaign. Attendance list and/or notices may be made from Audience/Users 526 registered with the media campaign. Invitations and reminders can be configured to be automatically sent out by the campaign management module 516 via the Messaging Manager Module 520 and messaging transmission and streaming content 524. Responses such as RSVPs and attendance confirmation may be received by the CMM 516 via the Messaging Reception Module 528.

A Rewards Module 540 is able to communicate with the CMM 516. The Rewards Module 540 tracks reward offers and rewards given. Rewards may be monitory, materials, or symbolic (i.e. points). The CMM 516 configures a reward and associates it to an activity, such as a level of participation, messaging, and/or attending or sponsoring events. The rewards are recorded as being associated with an Audience/User 526 in a datastore. The preferred storage method is using a blockchain. In some implementations, a unique cryptocurrency may be used associated with the APS system. Rewards may also be used to access special events or promotions, such as a dinner with a Star for a predetermined number of points. Messages sent only to Audience/Users 526 having a predetermined number of points. In some implementations, rewards may be associate with Audience/Users 526 and not reset between different media campaigns.

The Digital Media Input Module 508 is configured with a media campaign is set up in the current implementation. The Digital Media Input Module 508 enables digital content to be secured and authenticated (either manually or via machine validation) prior to being cataloged and stored in the Digital Media Store 510. The cataloging of the digital media enables hyperlinks to be assigned, keywords associated, and searches/sorting to be conducted on digital media used and/or generated by the media campaign. Further, external digital media may be accessed and brought into the APS system via the External Digital Media Store. As copyright laws and author restrictions may limit the actual importation of the digital media, links or other identifiers may be associated with the digital media and brought into the APS and stored in the Digital Media Store 510. It is noted that External digital media may be accessed via the network interface 108 through the internet or cloud 116 of FIG. 1. In other implementations, additional inputs, such as optical disk reader 120 of FIG. 1 may be used to have external digital media accessible to the APS 102 of FIG. 1 and CMM 516.

The Fundraising Module 542 is set up by the Media Campaign Setup 504 and accessed by the CMM 516. The Fundraising Module 542 tracks the messages that the CMM 516 sends out and the funds raised from those actions. The Fundraising Module 545 may have an application program interface (API) to access and share data with external accounting software that is either locally or remotely located. As political campaign fundraising at the Federal, State, and Local level is regulated. Part of the function of the Fundraising Modules 542 function is record keeping and compliance. As the Audience/User 526 information may include if they have restrictions or reporting requirements for providing funds to a campaign, the Fundraising Modules 542 monitors and enforces those restrictions. Further, a blacklist of donors may also be kept that prevents problematic donations. The blacklist of doners is set up via the CMM 516 and can also be a field in a user record stored in the User Information Store 522. In other media campaigns, fundraising may be for philanthropic endeavors associated with the media campaign. In yet other implementations, the media campaign can be for raising funds. For example, funds for building parks, hurricane victims, cancer research, and polio to name but a few. It is noted that External APS systems 505 may be allowed access via the CMM 516 for fundraising purposes and the Fundraising Module 542 may communicate directly with the Fundraising Module (not shown) of the external APS system 505. Thus, in some implementations, APS systems may be configured in a hierarchy such as a political party with a federal level, state level, and local level APS system. In yet other implements, the federal level, state level, and local level media campaigns by being implemented in a single APS system.

The Games Module 534 enable interactive games to be part of a media campaign and managed by the CMM 516. Games are loaded directly into the Games Module 534 which will have an associated datastore. The CMM 516 communicates via the Messaging Manager Module 520 and Messaging Transmission and Streaming Content Module 524 with the Audience/Users 526 to notify and provide access to the Audience/Users. The Audience/Users, via the APS client, can access the Games Module and run/play the games. External to the game rewards may be provided by the CMM 516 via the Rewards Module 540 for playing the games. The external rewards may be money, points, user status, ect . . . .

The Messaging Manager 520 coordinates the digital messaging that is sent out by the media campaign. The digital messaging may be via, email, advertisements, social media, press releases. The Messaging Transmission and Streaming Content Module 524 provides for the delivery of the digital content. In the current example implementation, all delivered content is accessed from the Digital Media Store 510. As the APS system is a one-screen system, feedback and/or comments are typically sought in response to the sending digital content from the Audience/Users 526. The digital content will typically be addressed from coming from the Star. But, it is also possible for the campaign to send informative digital content that may contain articles about the star or from an associated external APS system.

A Platform Manager Module 536 is managed from the CMM 516 and is coupled with the Messaging Manager Module 520. It allows a media campaign (political campaign) to list the issues that are in the candidate's platform. Messages may be sent to the Audience/Users 526 via the Messaging Manager Module 520 and Messaging Transmission and Streaming Content 524 seeking the issues that affect the Audience/Users 526 to be submitted and/or voted on. The results are made available and accessible by the APS client 136 where they can be displayed. The Star is also provided an area to comment on each platform issue. In some implementations, only the top 20 issues may be displayed or a predetermined number of issues displayed but ranked in response to the Audience/Users 526.

A Snail Mail Generator Module 525 is controlled by the messaging transmission and Streaming content Module 524. Mail and other types of messaging may be sent to copiers and printers that may also include devices that print and stuffs envelopes and apply postage. The Snail Mail Generator Module 525 may also contain device drivers or application program interfaces to other programs for the generation of snail mail (traditional postal service mail) that contains hard copies of the invitations and/or digital messages.

A Vote Reporting Module 530 enables a person to electronically vote in an election and/or other activities involving voting and provides an application program interface that securely communicates with a voting application 532. In some implementations, the voting application 532 will be provided by the organization holding the election (Federal, State, or local). In some implementations, the voting application 532 is provided by one or more entities not comprising the organization holding the election. It preferably will be provided, via an application program interface enabling the APS system 500 to exchange information with the external system controlled and secured by other organizations that are holding elections. If an Audience/Users have committed their vote in response to the media campaign, in response to a reward, or by playing a game, and allowed the reporting of the voting, the Vote Reporting Module 530 reports to the CMM 516 for whom or how a vote was cast (sent to the Voting Application 532). In some embodiments, a user had committed their vote and voted different than the commitment, the CMM 516 can suspend their account, send a message, remove rewards, and/or take actions. Voting is typically secret, but a person can tell others if they wish. Thus, the current implementation has the user giving permission to report their vote prior to their voting. Since the voting is occurring using the APS system, an option to opt-out of the reporting will be given in the current implementation. In some embodiments of the invention, the votes cast by users remain private or secret much the same as with traditional voting.

In some other embodiments of APS, means are provided to enable a user to selectively determine how and to whom the user's voting information is disclosed from one or more vote disclosure option choices. It is to be understood that implementation of vote information disclosure to a selected or otherwise authorized recipient by voter/users enables such a recipient (e.g., a person, party organization or political action group) to more effectively “deliver promised votes” to a candidate in an election or to a desired vote destination in one or more other vote-related activities involving otherwise secret balloting through the ability to monitor resulting voting selections made by users implementing the vote information disclosure feature(s) of the invention.

The Audience/Users 526 set up an APS account using the User/Audience Setup Module 506. Upon downloading and APS client to their device they can select the APS system 500 and communicate with the User/Audience Setup Module 506. In the APS processor-controlled client 136 FIG. 2, the user enters their name, age, address, email address, user name, password, likes, organizations and other data associated with the user's likes and interests. An IVE Module 506 verifies the user's age, name, affiliations by accessing other databases and blockchains. If a user had previously accessed the APS, its prior data may be used to verify the current data in the IE Module 506. The user information is encoded and stored in the User Information Store 522. In the current implementations, a blockchain is used to store and secure user information. But in other implementations encryption and/or blockchains may be used to secure the user information, including credit card and financial information. Upon completion of setting up an account in the APS system, a confirmation message is generated by the Messaging Manager 520 and send via text or email using the Messaging Transmission and Streaming Content Module 514.

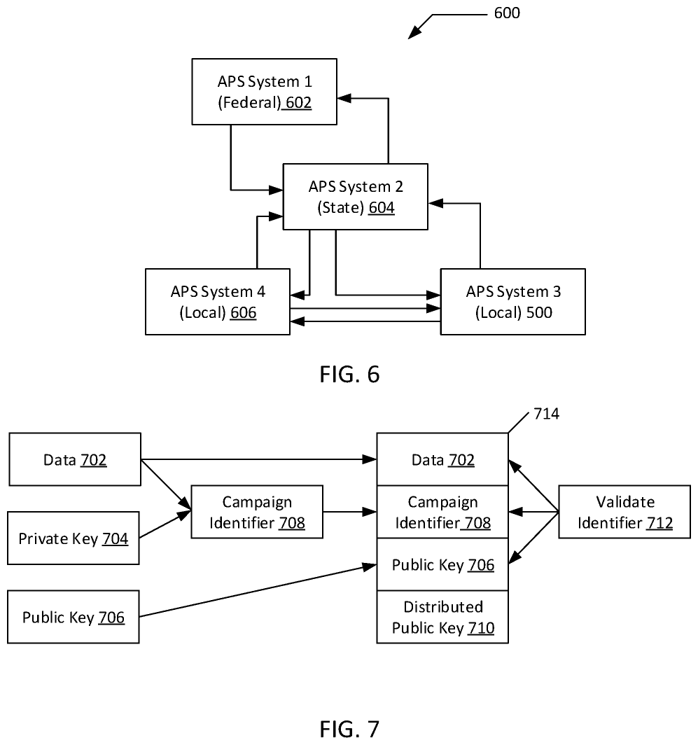

In FIG. 6, a block diagram 600 of a hierarchy of APS systems 602-606 and 500 of FIG. 5 is depicted in accordance with an example implementation. APS systems can interact with each other and take advantage of Stars and Audiences/Users of different media campaigns. Such an example is an APS system hosting a media campaign for a federal political campaign for presidency 602. A state-level political campaign on APS system 2 604 can be leveraged by the Federal APS campaign of APS system 1 602 as the APS System 1 can leverage the political campaign of APS system 2 604. Similarly, APS system 3 500 of FIG. 5 can leverage and be leveraged by the other APS systems 1 602 and APS where APS System 4 606 is at the same priority level of APS system 3 500. An advantage of the hierarchy of APS Systems is the ability to distribute the administration of the system. With a hierarchy of systems, the upper system may not have any users and only Stars that use the audience/users of the lower APS systems.

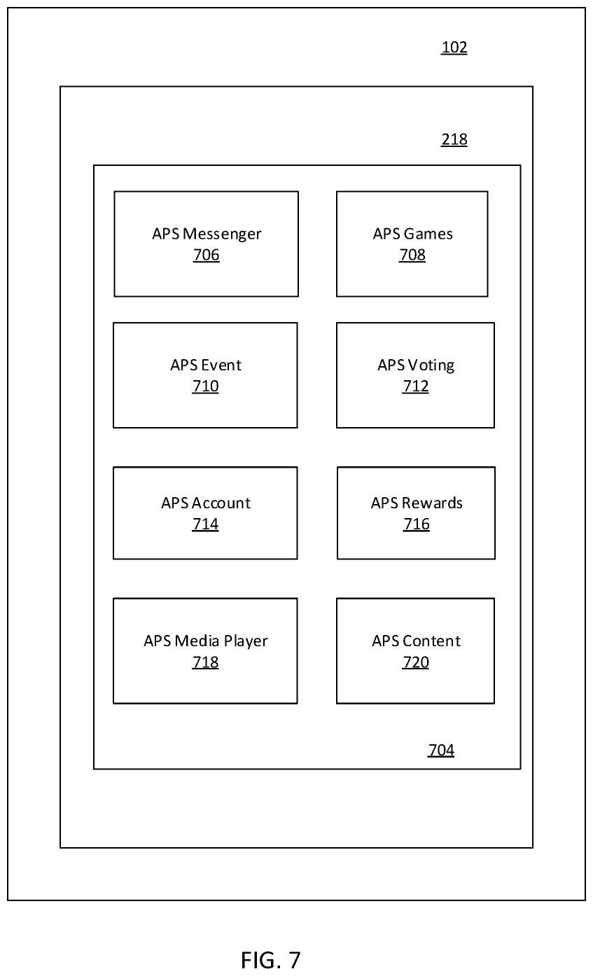

Turning to FIG. 7, a block diagram 700 of a blockchain data structure is depicted in accordance with an example implementation. Much of the data stored in the APS system can be stored in blockchains. The process of creating a blockchain is:
a. Take the data 702 that is being saved and create a unique campaign identifier 708 using the public encryption key 706 and private key 704.
b. Combine 714 the data 702 and the Campaign identifier 708, then add the public key 706 as well as the distributed Public Key 710.
   i. This block can represent any asset type, such as currency, points, user data, digital media, or other digital assets.
c. This transaction is then sent out into the blockchain world for validation and entry into the actual ledger that is a chain of blocks.
d. The combination of the data, the unique signature, and my public key is validated. by encryption technology (validate identifier 712).
e. If there's any attempt to modify the content of the block or the signature, the validation fail.
   This is a simplified explanation of a Blockchain, but for enablement purposes, it explains the essential elements and demonstrates how a Blockchain stores data and securely encode the data such that it is protected from modification.

In FIG. 8, a diagram 800 of the APS client 704 displayed on the display 218 of the processor-controlled client device 136 of FIG. 2 is depicted in accordance with an example implementation. The APS client 704 has selectable actions displayed in a graphical user interface. A user can select an action via the touch screen 238 of FIG. 1, mouse 224, or other selection type device. The APS Messenger button 706 indicates when a message is present. Different colors can indicate different types of messages, such as responses to previous messages, the priority of the message, to give but a few examples. In the current example, it changes color. In other implementations, a graphical image, audio alarm, or other visual alarm may be activated to signal reception of a message.

APS messages sent via the APS system 500 are received at the APS messenger and accessed by the APS Messenger button 706. In other implementations, messages are received as and accessed as email. In yet other implementations direct messaging to the APS messenger on the client may be sent from the APS server in addition to email being sent to a user's email account. The APS messenger may be used to send messages and respond to messages from the media campaign.

APS games may be accessed from the APS Games button 708. The Games may be downloaded, played, or removed by accessing the APS games via the APS Games button 708. It is noted that some of the games may require internet connectivity and/or downloading prior to playing.

The APS Event button 710 allows access to APS events notices that have been sent by the APS system 500. An event notice can be accessed, RSVPed too, copied into a calendar application running on the processor-controlled client device. The color of the APS Event button changes to signal when an event notification is available.

The APS Voting button 712 enables secure communication between the APS client 704 and the Vote Reporting Module 530/Voting Application 532 of the APS server 500 of FIG. 5. A user may cast their vote electronically in an election via accessing APS voting with the APS Voting button 712. An indicator, such as button color may be used to notify a user when electronic voting is allowed and if voting has occurred. In other implementations, other types of indicators may be used.

The APS Account button 714 interacts with the UserAudience Setup Module 506 in FIG. 5 to enable a user to set up or change account information and reverify the information if required. If encrypting is being used, an encryption key may be provided to the APS client 704 via the APS Account area accessed by the APS Account button 714 to decrypt messages and information.

An APS Rewards button 716 may be used to access reward information associated with the user. The APS Rewards screens can show earned rewards, pending rewards, rewards available to be earned. Rewards can also be converted or redeemed via the APS Rewards screen. The information accessed pertaining to rewards originates from the Rewards Module 540 of FIG. 5.

An APS Media Play may be accessed by selecting the APS Media Play button 718. The APS Media Play contains a plurality of codecs to play different file types (MP3, MP4, Flac, MOV, etc . . . ). The APS Media Player may also stream content securely from the Digital Media Store 510 of FIG. 5. In the current implementations, encrypted streams of data may be used with the APS Media Player that decrypts the encrypted streams.

Downloaded digital media may be stored on the processor-controlled client device 136 and accessed by selecting the APS Content button 720. Once selected, a screen listing downloaded content from the APS server 102 is displayed in a searchable display similar to a file manager.

In the current implementation, a number of features and buttons to access the client features have been described. In other implementations, more or less functionality may be available. In yet other implementations, different organizations of the buttons with fewer or more functionality may be available.

In some preferred embodiments of the invention, active political participation includes, without limitation, casting a vote, requesting an absentee ballot, digitally signing a petition, providing a monetary campaign contribution, providing opinion and/or other data via online Communication via surveys and the like, providing volunteer services, such as obtaining phone bank call lists and scripts, etc., providing a pledge of support. The key concept underlying and informing the APS is the creation and use of a platform that allows for both passive observing and actively participating on the same platform. One part of the APS, i.e. “one screen,” puts a subject politician directly in touch with the APS users on an interactive basis, while providing news and other content. The essence of APPlied Politics (APS) is, therefore, it's “one screen” and “one-stop shopping” approach to enabling the user to simultaneously obtain passive information and effectuate one or more political actions.

For example, on one screen a person may watch or others consume the news, and then, at the same time, the same system empowers a user to take or otherwise effectuate one or more political acts. In some preferred embodiments, the APS's unified screen interface graphically resembles or otherwise can be compared to a dashboard. In other embodiments, the APS processor-controlled client device's 136 user interface (i.e. touch screen, I/O 212, Keyboard 222, pen, and mouse 224) and display 218 are configured for use with a virtual reality device and/or an augmented reality device.

In some embodiments, the “one screen” idea of bringing informative and interactive functionality to an easy app status is embedded in the news screen, for example, as part of the originating content that streams into the screen. Thus the APS functionality would be included in the basic design of the platform and software to interface devices to the platform, and at the back end of the programming (e.g., in the servers, cloud, etc.)

In some embodiments, the APS provides the user with functionality to not only absorb the news but also interact directly with the Stars and the other content. Moreover, while adhering to proper laws, as applicable, and verified through the use of the IVE a user could sound off, engage with others, donate money, request an absentee ballot, and even, perhaps in the future, cast an actual ballot online. Most people believe that online voting is coming, but we all desire, of course, that such voting be tamper-proof, and that proofing will take some time—and so the APS through the use of the IVE and one or more Secured Verification Identifiers in association with the APS Profile, APPlied Politics can be seen as yet another milestone on the path to that goal.

In some embodiments, the interactivity mentioned above is embedded in a digital “skin,” or “frame” (“APPframe.”) The APPframe is, in effect, wrapped around existing content. It would a frame that's much more than an accouterment; it would be a working tool. For example, a traditional TV show could be enveloped in APPframe such that the viewer would at least be able, somewhat, to interact with the show, in the sense of doing it in real-time, on the same screen.

The added interactivity to the political experience; that is, to make the passive-news experience as active, and empowering, as the viewer or audience might wish is accomplished via the APS. And, also, as interactive as the politician might wish. For willing participants, a two-way street is a happy street. In other embodiments, the APS includes an elaborated version of the video on demand with additional features. That is, while there would be a schedule for the app, and there would be the capability of breaking in for big news. A user surveys the menu—including considering suggestions—and watch the provided content when convenient.

Once the two-way relationship is established via the APS, all sorts of new opportunities are provided. For instance, once users are inducted into a politics “club,” through the APS the powerful logic of tightly conceived, and tightly bound together, affinity groups are likely to manifest themselves. Such tightness is in sharp contrast to the way most social-media companies are conceived. Typically, the big social networks are open to all, and while the resulting size offers benefits, it also brings risks, as we have all learned. Specifically, openness brings with it many potential problems in politics, including the potential for disharmony, and even for outright fraud. In preferred embodiments, a member may circumscribe his or her world of friends, even if this demarcation is not always easy to actually do and doesn't always seem trustworthy.

By contrast, if the affinity group is tightly defined, then in some preferred embodiments users may invite, or exclude, members—according, of course, to lawful and transparent mechanisms—and this improves the odds of a harmonious group. Indeed, it would be possible to further assess the suitability of each member on an ongoing and real-time basis. That is, the group would ask: Are members doing what they promised they'd be doing? Are they following all the rules? Meeting all the metrics, including activism and/or dues? Such close interaction with members would enable APPlied Politics to make connections and suggestions—relating important news items, finding exciting candidates presented at virtual town halls, etc.—which would further serve the interests of each member.

In some embodiments blockchain and/or AI means are used to provide vetting of users and recordation of resultant findings. In some embodiments, such vetting can be continuous so that if, for some reason, a member falls out, well, that can be detected and the membership de-certified. Or, of course, the member could be found to be even more meritorious, as so recognized and celebrated. Also, security and confidence in the group make it possible to see microtransactions, and micropayment, as part of the APS system.

Abiding by such rules is often a vital concern to candidates and to political parties. That is, it's in their interest to say, upfront, that they want to build a community for likeminded adherents and supporters. This is how robust relationships are built. These criteria are based on any standard, and they can, of course, be adjusted, or tiered, as wished. For example, there could be one tier for insiders, one for newbies, and other tiers for others in other categories.

Still more possibilities, such as contests and gamification, are included in the APS example implementation. As with so many other human activities, contests and games are more fun with people you know. We can add that people who have a proven common interest with each other have a natural stake in preserving the relationship, e.g. being civil and playing fairly. One of the strengths of APPlied Politics (APS) is its focus on politics, including the spirit of cooperation and team play. And so in some preferred embodiments of the invention, an APPlied Politics group might choose to have a different kind of ownership status, conveying a political orientation, such as a non-profit or a cooperative. Moreover, since the heart of APPlied politics is presumed to be politics and elections, one could even posit that there'd be no need for non-political advertising since the politicians announcing themselves would be the prime source of revenue.

In some embodiments of an APS system, users are provided with the ability to join or be assigned by the APS system to, one or more teams or “tribes” that compete against another in one or more competitive computer games. In some embodiments of the invention, one or more of the APS system's user data acquisition, data analyzing and/or data exploitation modules are used to sort users into such teams or tribes for such gaming competition(s). Further, in some embodiments of the invention, the APS system provides means for political and/or social conflict exploitation gamification between one or more of such teams or tribes. In some embodiments, this takes the form of political debate or communication-based jousting between two or more competing users or two or more groups of competing users that is viewable and/or otherwise interacted with by an audience of one or more non-competing other users whereby such competing users are pitted against one another and awarded points or rewards based upon the recorded evaluations of users comprising the audience of non-competing users. In some embodiments, the competing users in such debates or other competition game provided by the APS system are among “Stars” (e.g, news anchors, pundits, politicians).

In some embodiments of the political and/or social conflict, exploitation gamification functions the competition is provided by the APS system between one or more persons, teams or tribes whereby the competition is effectuated through the virtual battling of Stars in a fantasy league-type application in which virtual representations of Stars or other political or social “champions” are chosen by the users to do battle against opposing or competing Stars or champions in a political debate or other competition.

In some embodiments of the invention, the gaming features are associated with a reward, or other payoff resulting from competitive victory. In some embodiments of the invention, the reward is the receipt of a pledge of the loser's vote for a candidate or cause, etc., whereby such vote is effectuated by the APS system or an associated online voting means. In some embodiments, such rewards and/or payoffs comprise a loser's transmission of a monetary or labor contribution to a campaign or other political or social cause.

In other embodiments of the invention, the APS system provides the means for computer gaming “battle royales” between two or more groups of users (teams, tribes, political party members, etc.).

In some embodiments of the invention, in regard to scoring and/or awarding of points or other indicia of reward in association with battles (e.g., debate jousting, etc.) or other contests among two or more users or groups of users, such scoring criteria and/or points comprise positive or negative awards based on actual (e.g. real world) or simulated (e.g., in fantasy league applications) events such as the presence or absence of a political scandal, an arrest, an allegation of inappropriate sexual advances, polling data, etc., pertaining to one or more Stars and/or other users or one or more virtual champions (e.g., in one or more embodiments providing a fantasy league-like gaming option

In some embodiments, the APS could truthfully label itself as “No ads, no algorithms.” That is, no ads other than politics—which is presumably what the member is looking for, and so would be unobjectionable—and no creepy algorithms. APPlied Politics is thus, in a way, a more modest undertaking than, say, serving up a profitable contextual advertisement for every user and every occasion. In some embodiments, the APS includes creative rewards programs for members within the APPlied Politics model. For example, the APS may include a rewards program for “frequent viewers.” Such rewards could comprise, without limitation, monetary compensation, credits, and/or one or more cryptocurrency rewards. Rewards could also be awarded for activities, such as attending rallies, press conferences and/or posting on social media. In fact, given the supreme value of the audience to politicos, in some embodiments users or the audience may be paid to watch digital content that is part of the media campaign. After all, in the attention economy, you want people to pay attention! In some embodiments, APS is configured to directly target “super voters” and “super activists.” To illustrate, we might recall that in Iowa in 2016, just 171,000 people participated in the Democratic presidential caucuses, and about 186,000 participated in the Republican presidential caucuses. That's a total of a little less than 360,000, which is about 12 percent of the Hawkeye State's population.

In some embodiments of the example implementation, the APS community-building works both ways. That is, one or more APS groups could impose requirements of some kind. In some embodiments such requirements may be, for example, be dues, and/or payments in “sweat equity,” such as measurable campaign volunteering or other activities, the performance of which (or lack thereof) may be tracked and recorded in the APS itself. As we have seen, the value of APPlied Politics is that it provides data about political activity. In some embodiments of the invention, these activities could be as simple as being tuned in to see a certain show—encouraged by gamification and other technologies—or as advanced as metrics for active participation in campaigns. In still other embodiments of the invention, the APS effectuates the tracking and dispensing of discounts, special deals, and other perks to members of an APS.

In still other embodiments, the APS provides the functionality to provide galleries for activists, even “halls of fame.” In some embodiments of the invention, the APS provides properly moderated forums, in which users may discuss and debate a political party's platform, using collaborative tools to parse out a language. Indeed, in some embodiments, APPlied Politics members are provided through the functionality of the APS the ability to watch themselves take action, such as canvassing a precinct, or they might wish to become an instant flash mob, or else watch a precinct, virtually. Obviously, there are privacy considerations inherent and all these activities, and yet these tend to be eased if the people involved are operating in a high trust environment, in which people choose to opt-in. That is, if party A trusts party B and know enough to vote for B or party B's candidate, then there's a higher presumption of goodwill.

In some preferred embodiments, the APS includes functionality to provide Citizen Relationship Management. And the same with Voter Relationship Management: if users are being trusted to do something that is, after all, a secret, then sincere goodwill is the key. The goal is to convert ideas and ideology into political- and group affinity, and then further convert into eyeballs and, then, finally, victories in elections. These aspects of the APS are somewhat similar to platforms as Change.org, ActBlue, WinRed, and Patreon, and yet APPlied Politics is different, in that it's intended to be more than just a platform for transactions, it's also a platform for news, interactivity, and community. It's simply a better version of the proverbial mousetrap: That is, better than cable news and better than existing social media.

As previously mentioned, the APS is configured to provide security to users and operators through the use of biometrics, and blockchain technologies, and other security safeguards as they are developed. That is, with the full acquiescence of the member, the political Star can know who's involved, whether or not they members in good standing, and so on. Indeed, with blockchain, it's increasingly easy to keep track of people's doings, at least in the political sphere—provided, of course, that they have given appropriate consent to be so measured, as part of their membership. Once again, nobody's making anyone do any this; the issue is that if one does give consent, then one gets benefits: That's the sort of give-and-take that's at the heart of any strong relationship, and it's what APPlied Politics is all about.

APPlied Politics is intended to be a better place to be political, to be politically active, and to do the true work of responsible self-government.

Effectuating the reporting, accounting, tracking and/or payment of obligations, including without limitation, those associated with political contributions, political campaign expense payments, the fulfillment of volunteer obligations, license fee payments, etc. including without limitation those associated with one or more agreements generated in association with the use of an APS. Political activities, such as voting (e.g., online voting) often presents the problem of confirming the identity of the party engaged in the political activity there is a need to securely and definitively confirm the identity of the political participant as well as a need to quickly, efficiently and securely store data regarding online political activities such as online voting.

Using Blockchain technology, in the preferred embodiments, a plurality of aspects or indicia of identification can be aggregated in a secure legacy format that can be used to provide authentication of identification and/or authentication of identification elements (e.g., age, majority status, voting status, etc.) without the requirement of redundantly verifying such identification and/or identification elements. In some embodiments, the IVE operates through the use of a Blockchain to continually build a more reliable identity source with every transaction and other activity using the IVE until the identity chain of the user reaches the desired level of trust and reliability resulting from the plurality of identity affirming actions tracked and stored secured via the aforementioned Blockchain.

The IVE functions is used to verify the identity of one or more content participants or other users of an APS through fingerprints and other biometric data, birth certificate data, education data, genealogical record data, dental record data, medical record data, financial institutional records data, published work data, copyright data, patent data, etc. It is to be understood that in some embodiments of the invention a content participant using an APS can be a human person, an autonomous computing device, an AI device, a robot or other non-human device and/or an animal configured to interact with the APS through the use of “Source Records” and/or other identification data associated with such person, entity, device or animal, including without limitation photographic data, government identification (such as driver license data, passport data, etc.), DNA data, voice recognition data, retina scan data, blood type or other serological data, Brain Mapping and other types of cerebral mapping data by showing the unique cerebral pattern identified through MRI, x-ray, electronic graph or other similar device that will display a map/brain print/blueprint (fingerprint of the brain). Because each person has a unique set of experiences and memories and no two are identical. When the memories are storied unique neurons and the like create unique pathways based on the individual's life. The Brain Mapping or other cerebral maps by showing the unique cerebral pattern identified through MRI, x-ray, electronic graph or another similar device that will display a map/brain print (Fingerprint of the brain). Because each person has unique experiences and memories and no two are identical. When the memories are storied unique neurons and the like create unique pathways based on the individual's life. The cerebral map will be unique like a fingerprint.

Enhancement and/or other body modification data (such as technological enhancements, bionics, implanted electronic components and/or, embedded surgical items such as breast augmentation, or other types of physically identifying data, such as scars, Tattoos, RFID chips (or similar device), genetic modifications, historical data (such as geolocation data, associated event data, social history, and other interpersonal historical data), creation date data, serial number/s, part number/s, and the like.

In some embodiments the IVE can be used to verify the age of a human being or other living individual, a device or other non-living item, a group of persons or a group of items, an AI device, using the Source Records and/or the Secure Verification Identifier. In some embodiments the IVE can request additional records other than Sources Records, or other information from an individual, person, group, autonomous computing device, robot, AI device, non-human entity, and/or intelligent hybrid chimera/human hybrid animal if the IVE determines the initial Source Records could not adequately identify the individual, person, group, persons, AI, Non-Human, Animal. In some preferred embodiments, the IVE provides one or more requests for more records to be determined by the submitter to verify the identity.

In some embodiments, once the Source Records and/or other data used to verify the identity of a content participant are used by the IVE to perform the identification verification process, a copy of the Source Records and/or other identifying information used are stored in a Secure Storage. In some preferred embodiments of the invention, once the Source Records and/or other identifying information used are stored in a Secure Storage, the Content Participant is given a Secure Verification Identifier such as, but not limited to, a Blockchain, encryption key, holographic imprint, digital tattoo, etc. This Secure Verification Identifier can be used by IVE in association with the functioning of one or more APSs or part(s) thereof.

In some embodiments the IVE can be set to limit the type or amount of Source Records and/or other identification data to be included in the IVE and/or to be used by the IVE. In some embodiments, the IVE can also be set allow future changes such as the addition of additional Source Records or other identification data when a specified condition is met and/or the IVE can be open to allow a content participant to add new Source Records to the Source Records stored in the Secure Storage of the IVE. In some embodiments the IVE can be set with preferences restricting the addition of new Source Records once a Secure Verification Identifier has been assigned. In some embodiments, if the IVE is enabled to allow new Source Records to be added to the Secure Storage for the content participant the IVE can be configured to create a new Secure Verification Identifier for the content participant.

In some embodiments, the IVE can be set with preferences restricting the kind of Source Records and/or other identification data that can be used and/or under what circumstances copies of them can be added or removed. The IVE can allow one or more third-party operated devices, autonomous computing devices, AI devices, or one or more other specified devices, including without limitation, one or more such devices provided with a Secure Verification Identifier to access one or more Source Records and/or other identification data stored in Secured Storage, database, Blockchain, or otherwise stored in or associated with the IVE.

Social relationships or groups may be formed using the APS. Some examples of such relationships or groups are all persons indicating a preference for a particular candidate in a defined geographic area. Also, in some embodiments of the APS may be used for purposes of effectuating political and non-political marketing campaigns through the use of one or more online or offline advertising programs, systems, methods, platforms or other devices, including without limitation one or more such embodiments described in U.S. Pat. No. 8,554,870, including without limitation, one or more online or offline programs, systems, methods or platforms operated by one or more computers, autonomous computing devices, robots and/or artificial intelligence devices.

Political and non-political crowdfunding campaigns, including without limitation, the works resulting from the operation of one or more online or offline advertising programs, systems, methods, platforms or other devices, including without limitation one or more online or offline programs, systems, methods or platforms operated by one or more computers, autonomous computing devices, robots and/or artificial intelligence devices.

In some preferred embodiments of the invention, crowd-sourced projects, including without limitation, campaign-related tasks such as phone bank operations and neighborhood canvassing, etc., can be effectuated through the operation of one or more online or offline advertising programs, systems, methods, platforms or other devices in association with one or more APSs, including without limitation one or more online or offline programs, systems, methods or platforms operated by one or more computers, autonomous computing devices, robots and/or artificial intelligence devices.

In some embodiments of the invention, the software in software memory may include an ordered listing of executable instructions for implementing logical functions (that is, “logic” that may be implemented either in digital forms such as digital circuitry or source code or in analog forms such as analog circuitry or an analog source such an analog electrical, sound or video signal), and may selectively be embodied in any computer-readable medium for use by or in connection with an instruction execution system, apparatus, or device, such as a computer-based system, processor containing system, or other system that may selectively fetch the instructions from the instruction execution system, apparatus, or device and execute the instructions. In the context of this disclosure, a “computer-readable medium” is any tangible means that may contain or store the program for use by or in connection with the instruction execution system, apparatus, or device. The tangible computer-readable medium may selectively be, for example, but is not limited to, an electronic, magnetic, optical, electromagnetic, or semiconductor system, apparatus or device. More specific examples, but nonetheless a non-exhaustive list, of tangible computer-readable media, would include the following: a portable computer diskette (magnetic), a RAM (electronic), a read-only memory “ROM” (electronic), an erasable programmable read-only memory (EPROM or Flash memory) (electronic) and a portable compact disc read-only memory “CDROM” (optical). Note that the tangible computer-readable medium may even be paper (punch cards or punch tape) or another suitable medium upon which the instructions may be electronically captured, then compiled, interpreted or otherwise processed in a suitable manner if necessary, and stored in computer memory.

In some embodiments of the invention, the APS is configured to Communicate and/or otherwise interface with other devices and systems, including, without limitation, Public Computers, Semi-Public computers, wearable computers, devices storing Source Records, voting machines, online collaboration systems, billboards, and other display devices

In some preferred embodiments of the invention, the aforementioned display devices comprise flexible or non-flat displays.

In some preferred embodiments of the invention, the aforementioned flexible or non-flat displays comprise displays configured on clothing, billboards, and other objects.

In some preferred embodiments of the invention, the aforementioned flexible or non-flat displays on other objects include without limitation displays configured on or as electronic bumper stickers or on or as hats.

In some preferred embodiments, the APS provides an electronic bumper sticker or item of clothing configured with a flexible or non-flat display capable of receiving display information wirelessly via WiFi or Bluetooth® transmissions predetermined messages, such as political messages based on the location of such flexible or non-flat display. For example, assume User A, a supporter of Candidate X, has such an electronic bumper sticker in direct or indirect communication with the APS whereby the APS is provided with the location of the electronic bumper sticker can be provided with various messages to the electronic bumper sticker based on the political demography of the neighborhoods through which he or she is driving so that the verbiage appearing on the display of the bumper sticker in support of Candidate X is optimized to produce the political effect in the neighborhoods through which User A is driving. For example, as User A moves from parts of her town in which the local population predominantly speaks English to parts where Spanish is predominantly spoken then the language of the message in support of Candidate X changes from English to Spanish based on the location of User A's phone.

The foregoing detailed description of one or more embodiments of the approach for an APS approach that provides for a “two-screen” communication in a media campaign has been presented herein by way of example only and not limitation. It will be recognized that there are advantages to certain individual features and functions described herein that may be obtained without incorporating other features and functions described herein. Moreover, it will be recognized that various alternatives, modifications, variations, or improvements of the above-disclosed embodiments and other features and functions, or alternatives thereof, may be desirably combined into many other different embodiments, systems or applications. Presently unforeseen or unanticipated alternatives, modifications, variations, or improvements therein may be subsequently made by those skilled in the art which are also intended to be encompassed by the appended claims. Therefore, the spirit and scope of any appended claims should not be limited to the description of the embodiments contained herein.

What is claimed is:

1. A media campaign management system, comprising:
a processor;
at least one data store in communication with the processor, having at least one data structure to store data that include digital media data, user data, and rewards;
a campaign management module executed by the processor that is able to access the at least one data store and manages electronic messages sent to users with digital media data and issue rewards in response to at least one received message received in response to the sent electronic messages; and
a vote reporting module executed by the processor in communication with the campaign management module with an application program interface to enable communication with a voting applicaiton so the user is able to cast a vote.

2. The media campaign management system of claim 1, where the vote reporting module records the vote in the data store.

3. The media campaign management system of claim 1, where the voting application further includes a plurality of instructions that are executed by the processor within the media campaign system.

4. The media campaign management system of claim 1, where the at least one data store includes at least one Blockchain that stores user data.

5. The media campaign management system of claim 1, includes a platform manager module executed by the processor that generates a platform display in response to messages received from the user.

6. The media campaign management system of claim 1, where the data store stores data that has been encrypted by the processor.

7. The media campaign management system of claim 1, where the received message contains location identification data.

8. The media campaign management system of claim 7, where the location identification data is GPS data.

9. A method for media campaign management, comprising:
Storing in at least one data store having a data structure to store data that include digital media data, user data, and rewards, where the data store is in communication with a processor;
accessing the at least one data store with a campaign management module, where the campaign management module generates electronic messages sent to users;
issuing rewards by the campaign management module in response to at least one message from the user; and
communicating with a voting application via a vote reporting module, that enables the user is able to cast a vote in the voting application.

10. The method for the campaign system of claim 1, includes recording the vote in the data store.

11. The method for the campaign system of claim 1, includes executing a plurality of institutions by the processor, that when executed results in the voting application.

12. The method for the campaign system of claim 1, where the at least one data store includes at least one Blockchain that stores user data.

13. The method for the campaign system of claim 1, includes generating a platform display in response to messages received from the user at a platform manager module executed by the processor.

14. The method for the campaign system of claim 1, includes encrypting the data store stores by the processor.

15. The media campaign management system of claim 1, where the received message contains location identification data.

16. The media campaign management system of claim 7, where the location identification data is GPS data.

17. A non-transient machine-readable media having a plurality of instructions for media campaign management, that when executed performs the method steps of:
Storing in at least one data store having a data structure to store data that include digital media data, user data, and rewards, where the data store is in communication with a processor;
accessing the at least one data store with a campaign management module, where the campaign management module generates electronic messages sent to users;
issuing rewards by the campaign management module in response to at least one message from the user; and
communicating with a voting application via a vote reporting module, that enables the user is able to cast a vote in the voting application.

18. The non-transient machine-readable media having a plurality of instructions for media campaign management of claim 1, includes recording the vote in the data store.

19. The non-transient machine-readable media having a plurality of instructions for media campaign management of claim 1, includes executing a plurality of institutions by the processor, that when executed results in the voting application.

20. The non-transient machine-readable media having a plurality of instructions for media campaign management of claim 1, where the at least one data store includes at least one Blockchain that stores user data.
